(19) United States
(12) Patent Application Publication
(10) Pub. No.: US 2026/0167237 A1
(43) Pub. Date: Jun. 18, 2026

(54) INFORMATION PROCESSING APPARATUS, INFORMATION PROCESSING SYSTEM, INFORMATION PROCESSING METHOD, AND VEHICLE

(71) Applicant: TOYOTA JIDOSHA KABUSHIKI KAISHA, Toyota-shi (JP)

(72) Inventors: Kiyotaka MORIIZUMI, Nisshin-shi (JP); Mitsuhiro MIURA, Toyota-shi (JP); Yoshiaki TOMATSU, Toyoake-shi (JP)

(73) Assignee: TOYOTA JIDOSHA KABUSHIKI KAISHA, Toyota-shi (JP)

(21) Appl. No.: 19/421,816

(22) Filed: Dec. 16, 2025

(30) Foreign Application Priority Data
Dec. 18, 2024 (JP) 2024-223133

(51) Int. Cl. B60W 60/00; B60W 50/00; G05D 1/227

(52) U.S. Cl. CPC B60W 60/0054; B60W 50/0098; G05D 1/227; B60W 2555/20; B60W 2556/45

(57) ABSTRACT

An information processing apparatus includes a controller that acquires evaluation information based on measurement data from sensors provided in a vehicle, which has an automated driving mode and a manual driving mode capable of manual driving by an operator. When switching from the automated driving mode to the manual driving mode, the controller sets a response level for the manual driving based on the evaluation information, and selects an operator who is allowed to perform the manual driving of the vehicle, based on the response level and the skill level of the operator.

### CROSS-REFERENCE TO RELATED APPLICATION

This application claims priority to Japanese Patent Application No. 2024-223133 filed on Dec. 18, 2024, the entire contents of which are incorporated herein by reference.

### TECHNICAL FIELD

The present disclosure relates to an information processing apparatus, an information processing system, an information processing method, and a vehicle.

### BACKGROUND

Technology related to the automated control of travel of vehicles is known. For example, Patent Literature (PTL) 1 discloses a manual driving switching system for automobiles that can easily determine a driver's driving skill level and determine whether to permit switching from automated driving to manual driving based on the driver's skill level.

### CITATION LIST

### Patent Literature

PTL 1: JP 2018-124686 A.

### SUMMARY

However, there may be cases in which manual driving by operators is required depending on situations encountered by automated driving vehicles. At this time, it is assumed that in some situations, it may be difficult for some operators to respond to the situations by manual driving. It is necessary to assign operators capable of responding by manual driving depending on the situations. Therefore, there is room for improvement in technology for switching from automated driving to manual driving for vehicles.

It would be helpful to improve technology for switching from automated driving to manual driving for vehicles.

An information processing apparatus according to an embodiment of the present disclosure includes a controller configured to:

acquire evaluation information based on measurement data from a sensor provided in a vehicle that has an automated driving mode and a manual driving mode capable of manual driving by an operator;

when switching from the automated driving mode to the manual driving mode, set a response level for the manual driving based on the evaluation information; and

select an operator who is allowed to perform the manual driving of the vehicle, based on the response level and a skill level of the operator.

An information processing system according to an embodiment of the present disclosure includes:

the information processing apparatus described above; and

the vehicle configured to:
acquire the measurement data using the sensor; and
acquire the evaluation information based on the acquired measurement data, and provide the evaluation information to the information processing apparatus.

An information processing method according to an embodiment of the present disclosure is an information processing method performed by an information processing apparatus, the information processing method including:

acquiring evaluation information based on measurement data from a sensor provided in a vehicle that has an automated driving mode and a manual driving mode capable of manual driving by an operator;

when switching from the automated driving mode to the manual driving mode, setting a response level for the manual driving based on the evaluation information; and

selecting an operator who is allowed to perform the manual driving of the vehicle, based on the response level and a skill level of the operator.

A vehicle according to an embodiment of the present disclosure is a vehicle configured with an automated driving mode and a manual driving mode capable of manual driving by an operator, the vehicle including:

a sensor; and

a controller configured to acquire evaluation information based on measurement data from the sensor,

wherein when switching from the automated driving mode to the manual driving mode, the controller is configured to set a response level for the manual driving based on the evaluation information, and provide the evaluation information to an information processing apparatus that selects an operator who is allowed to perform the manual driving of the vehicle, based on the response level and a skill level of the operator.

According to an embodiment of the present disclosure, technology for switching from automated driving to manual driving for vehicles is improved.

### BRIEF DESCRIPTION OF THE DRAWINGS

In the accompanying drawings:

FIG. 1 is a configuration diagram illustrating an example of a configuration of an information processing system that includes an information processing apparatus according to an embodiment of the present disclosure;

FIG. 2 is a table diagram illustrating a first example of evaluation information generated by a determination apparatus of a vehicle of FIG. 1;

FIG. 3 is a table diagram illustrating a second example of the evaluation information generated by the determination apparatus of the vehicle of FIG. 1;

FIG. 4 is a table diagram illustrating a third example of the evaluation information generated by the determination apparatus of the vehicle of FIG. 1;

FIG. 5 is a table diagram illustrating an example of operations of the information processing apparatus of FIG. 1;

FIG. 6 is a first flowchart illustrating an example of an information processing method performed by the information processing system of FIG. 1;

FIG. 7 is a second flowchart illustrating the example of the information processing method performed by the information processing system of FIG. 1;

FIG. 8 is a third flowchart illustrating the example of the information processing method performed by the information processing system of FIG. 1;

FIG. 9 is a fourth flowchart illustrating the example of the information processing method performed by the information processing system of FIG. 1;

FIG. 10 is a fifth flowchart illustrating the example of the information processing method performed by the information processing system of FIG. 1;

FIG. 11 is a sixth flowchart illustrating the example of the information processing method performed by the information processing system of FIG. 1; and

FIG. 12 is a seventh flowchart illustrating the example of the information processing method performed by the information processing system of FIG. 1.

### DETAILED DESCRIPTION

Hereinafter, an embodiment of the present disclosure will be described with reference to the accompanying drawings. The following description regarding an information processing apparatus 30 also applies to an information processing system 1 including the information processing apparatus 30, an information processing method performed by the information processing apparatus 30, a program that causes the information processing apparatus 30 as a computer to execute operations, a vehicle 10, and a determination apparatus 20 to which the present disclosure is applied.

### Outline of Embodiment

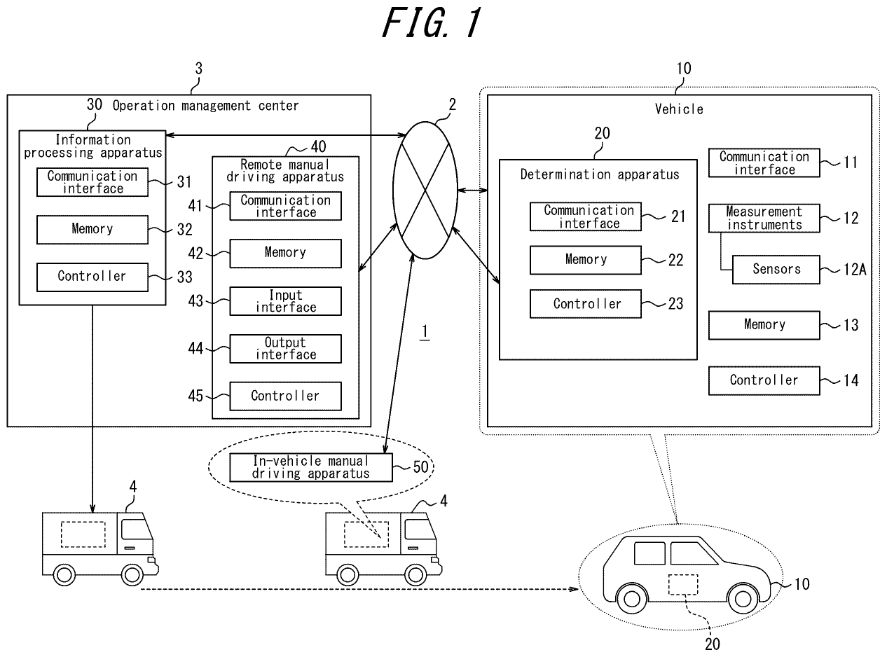

FIG. 1 is a configuration diagram illustrating an example of a configuration of an information processing system 1 including an information processing apparatus 30 according to the embodiment of the present disclosure. With reference to FIG. 1, the example of the configuration of the information processing system 1 including the information processing apparatus 30 according to the embodiment of the present disclosure will be primarily described. The information processing system 1 includes a vehicle 10, a determination apparatus 20 mounted in the vehicle 10, the information processing apparatus 30 and a remote manual driving apparatus 40 installed in an operation management center 3, and an in-vehicle manual driving apparatus 50 to be temporarily installed in the vehicle 10.

In FIG. 1, for the purpose of simplicity, only one vehicle 10, one determination apparatus 20, one information processing apparatus 30, one remote manual driving apparatus 40, and one in-vehicle manual driving apparatus 50 are illustrated, but the number of each type of apparatuses in the information processing system 1 may be two or more. The vehicle 10, the determination apparatus 20, the information processing apparatus 30, the remote manual driving apparatus 40, and the in-vehicle manual driving apparatus 50 are communicably connected to a network 2 that includes, for example, the Internet, a mobile communication network, or the like. Any of the vehicle 10, the determination apparatus 20, the information processing apparatus 30, the remote manual driving apparatus 40, or the in-vehicle manual driving apparatus 50 is communicably connected to the other apparatuses via the network 2.

The vehicle 10 includes, for example, an automobile that has a Level 4 (Lv4) automated driving function. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 10 is communicably connected via the network 2 to the determination apparatus 20, the information processing apparatus 30, the remote manual driving apparatus 40, and the in-vehicle manual driving apparatus 50. The vehicle 10 may be communicably connected via wires to each of the determination apparatus 20 and the in-vehicle manual driving apparatus 50.

The vehicle 10 has an automated driving mode and a manual driving mode that enables manual driving by an operator. In the present disclosure, the “manual driving mode” includes, for example, a remote manual driving mode that performs manual driving outside the vehicle 10 and an in-vehicle manual driving mode that performs manual driving inside the vehicle 10. The remote manual driving mode is a mode in which the vehicle 10 is manually driven using the remote manual driving apparatus 40 from the operation management center 3 located remotely. The in-vehicle manual driving mode is a mode in which the vehicle 10 is manually driven using the in-vehicle manual driving apparatus 50 temporarily installed in the vehicle 10.

The determination apparatus 20 includes, for example, a computer mounted in the vehicle 10. The determination apparatus 20 is communicably connected via the network 2 to the vehicle 10, the information processing apparatus 30, the remote manual driving apparatus 40, and the in-vehicle manual driving apparatus 50. The determination apparatus 20 may be communicably connected via wires to each of the vehicle 10 and the in-vehicle manual driving apparatus 50.

The information processing apparatus 30 includes, for example, a single server apparatus or a plurality of server apparatuses that can communicate with each other. The information processing apparatus 30 is not limited to these, and may include any general purpose electronic device such as a personal computer (PC), a tablet PC, a smartphone, or a wearable device like a smartwatch, or may include another electronic device dedicated to the information processing system 1. The information processing apparatus 30 is, for example, an apparatus operated by the operation management center 3. The information processing apparatus 30 is communicably connected via the network 2 to the vehicle 10, the determination apparatus 20, the remote manual driving apparatus 40, and the in-vehicle manual driving apparatus 50.

The remote manual driving apparatus 40 includes, for example, a control apparatus installed in the operation management center 3. By operations of an operator at the operation management center 3, which is located remotely from the vehicle 10, the remote manual driving apparatus 40 monitors the vehicle 10 and performs manual driving of the vehicle 10 via the network 2. The remote manual driving apparatus 40 is communicably connected via the network 2 to the vehicle 10, the determination apparatus 20, the information processing apparatus 30, and the in-vehicle manual driving apparatus 50.

The in-vehicle manual driving apparatus 50 includes a control apparatus to be used when an operator of a rescue team 4, who has accepted a request from the information processing apparatus 30 for the dispatch of the operator to the vehicle 10, proceeds to the vehicle 10 and operates the vehicle 10 manually. The in-vehicle manual driving apparatus 50 is, for example, temporarily installed in the vehicle 10 that has no mechanical operation unit for manual driving. The rescue team 4 is a team on standby at a rescue center provided in the operation management center 3 or away from the operation management center 3. The in-vehicle manual driving apparatus 50 is communicably connected via the network 2 to the vehicle 10, the determination apparatus 20, the information processing apparatus 30, and the remote manual driving apparatus 40. The in-vehicle manual driving apparatus 50 may be communicably connected via wires to each of the vehicle 10 and the determination apparatus 20.

Configurations of the information processing system 1 will be described below in detail.

### Configuration of Vehicle 10

The vehicle 10 includes a communication interface 11, measurement instruments 12, a memory 13, a controller 14, and the determination apparatus 20.

The communication interface 11 includes at least one communication interface for connecting to the network 2. The communication interface is compliant with a mobile communication standard such as Long Term Evolution (LTE), 4th Generation (4G), or 5th Generation (5G), a wired local area network (LAN) standard, or a wireless LAN standard, but is not limited to these and may be compliant with any communication standard. For example, the communication interface may also be compliant with a short-range wireless communication standard. In the present embodiment, the vehicle 10 is communicably connected to the network 2 via the communication interface 11. The communication interface 11 transmits and receives various types of information via the network 2. Additionally, the communication interface 11 also includes a communication interface that is connected via a wire to a controller area network (CAN) of the vehicle 10.

The measurement instruments 12 include sensors 12A. The sensors 12A include, for example, a first sensor for monitoring the environment around the vehicle 10 traveling under automated driving and a second sensor mounted on a self-diagnostic apparatus or the like of the vehicle 10 to diagnose a failure mode. The first sensor of the sensors 12A includes a camera, 3D light detection and ranging (LiDAR), a millimeter-wave sensor, an accelerometer, a global positioning system (GPS) sensor, or the like. The types of sensors 12A are not limited to these.

The memory 13 includes one or more memories. In the present disclosure, the “memories” include semiconductor memories, magnetic memories, optical memories, or the like, for example, but are not limited to these. The memories included in the memory 13 may each function as, for example, a main memory, an auxiliary memory, or a cache memory. The memory 13 stores information necessary to realize operations of the vehicle 10. For example, the memory 13 may store a system program, an application program, embedded software, or the like. The memory 13 stores information obtained by operations of the vehicle 10. The information stored in the memory 13 may be updated with information acquired from the network 2 via the communication interface 11, for example.

The controller 14 includes at least one processor, at least one programmable circuit, at least one dedicated circuit, or a combination of these. In the present disclosure, the “processor” is a general purpose processor such as a central processing unit (CPU) or a graphics processing unit (GPU), or a dedicated processor specialized for specific processing, for example, but is not limited to these. The “programmable circuit” is, for example, a field-programmable gate array (FPGA), but is not limited to this. The “dedicated circuit” is, for example, an application specific integrated circuit (ASIC), but is not limited to this. The controller 14 controls operations of the entire vehicle 10, including Lv4 automated driving and manual driving linked with the remote manual driving apparatus 40 or the in-vehicle manual driving apparatus 50 described later.

### Configuration of Determination Apparatus 20

The determination apparatus 20 includes a communication interface 21, a memory 22, and a controller 23.

The communication interface 21 includes at least one communication interface for connecting to the network 2. The communication interface is compliant with a mobile communication standard such as LTE, 4G, or 5G, a wired LAN standard, or a wireless LAN standard, but is not limited to these and may be compliant with any communication standard. For example, the communication interface may also be compliant with a short-range wireless communication standard. In the present embodiment, the determination apparatus 20 is communicably connected to the network 2 via the communication interface 21. The communication interface 21 transmits and receives various types of information via the network 2. In addition, the communication interface 21 also includes a communication interface that is connected with a wire to the CAN of the vehicle 10.

The memory 22 includes one or more memories. The memories included in the memory 22 may each function as, for example, a main memory, an auxiliary memory, or a cache memory. The memory 22 stores information necessary to realize operations of the determination apparatus 20. For example, the memory 22 may store a system program, an application program, embedded software, or the like. The memory 22 stores information obtained by operations of the determination apparatus 20. The information stored in the memory 22 may be updated with, for example, information acquired from the network 2 via the communication interface 21.

The controller 23 includes at least one processor, at least one programmable circuit, at least one dedicated circuit, or a combination of these. The controller 23 is communicably connected to components of the determination apparatus 20 and controls operations of the entire determination apparatus 20. The controller 23 continuously monitors whether design requirements (hereinafter also referred to as operation design domain (ODD)) that enable automated driving of the vehicle 10 are satisfied, based on measurement data and the like from the sensors 12A. When the ODD is not satisfied, the controller 23 generates evaluation information, which will be described later. When a predetermined condition is satisfied, the controller 23 provides the evaluation information to the information processing apparatus 30 operated by the operation management center 3, and requests that some response be implemented to address the ODD deviation.

### Configuration of Information Processing Apparatus 30

The information processing apparatus 30 has a communication interface 31, a memory 32, and a controller 33.

The communication interface 31 includes at least one communication interface for connecting to the network 2. The communication interface is compliant with a mobile communication standard such as LTE, 4G, or 5G, a wired LAN standard, or a wireless LAN standard, but is not limited to these and may be compliant with any communication standard. For example, the communication interface may also be compliant with a short-range wireless communication standard. In the present embodiment, the information processing apparatus 30 is communicably connected to the network 2 via the communication interface 31. The communication interface 31 transmits and receives various types of information via the network 2.

The memory 32 includes one or more memories. The memories included in the memory 32 may each function as, for example, a main memory, an auxiliary memory, or a cache memory. The memory 32 stores information necessary to realize operations of the information processing apparatus 30. For example, the memory 32 may store a system program, an application program, embedded software, or the like. The memory 32 stores information obtained by operations of the information processing apparatus 30. The information stored in the memory 32 may be updated with, for example, information acquired from the network 2 via the communication interface 31.

The controller 33 includes at least one processor, at least one programmable circuit, at least one dedicated circuit, or a combination of these. The controller 33 is communicably connected to each component included in the information processing apparatus 30 and controls operations of the entire information processing apparatus 30.

### Configuration of Remote Manual Driving Apparatus 40

The remote manual driving apparatus 40 includes a communication interface 41, a memory 42, an input interface 43, an output interface 44, and a controller 45.

The communication interface 41 includes at least one communication interface for connecting to the network 2. The communication interface is compliant with a mobile communication standard such as LTE, 4G, or 5G, a wired LAN standard, or a wireless LAN standard, but is not limited to these and may be compliant with any communication standard. For example, the communication interface may also be compliant with a short-range wireless communication standard. In the present embodiment, the remote manual driving apparatus 40 is communicably connected to the network 2 via the communication interface 41. The communication interface 41 transmits and receives various types of information via the network 2.

The memory 42 includes one or more memories. The memories included in the memory 42 may each function as, for example, a main memory, an auxiliary memory, or a cache memory. The memory 42 stores information necessary to realize operations of the remote manual driving apparatus 40. For example, the memory 42 may store a system program, an application program, embedded software, or the like. The memory 42 stores information obtained by operations of the remote manual driving apparatus 40. The information stored in the memory 42 may be updated with, for example, information acquired from the network 2 via the communication interface 41.

The input interface 43 includes at least one input interface for detecting user input to acquire input information based on operations by an operator. The input interface includes physical keys, capacitive keys, a pointing device such as a mouse, a touch screen integrally provided with a display of the output interface 44, an imaging module such as a camera, a microphone that accepts audio input, a biometric authentication module for vein or fingerprint authentication, or the like. The input interface 43 may include any other input interfaces, not limited to these. The input interface 43 may be connected to the remote manual driving apparatus 40 as an external input device, instead of being included in the remote manual driving apparatus 40. As the connection method, any method such as Universal Serial Bus (USB), High-Definition Multimedia Interface (HDMI®: HDMI is a registered trademark in Japan, other countries, or both), or Bluetooth® (Bluetooth is a registered trademark in Japan, other countries, or both) can be used.

The output interface 44 includes at least one output interface for outputting information to an operator who uses the remote manual driving apparatus 40. The output interface includes a display that visually outputs information as images, a speaker that audibly outputs information as audio, a vibrator that tactilely outputs information as vibration, or the like. In the present disclosure, the “display” includes, for example, a liquid crystal display (LCD) or an organic electro luminescent (EL) display, or the like. The output interface 44 may be connected to the remote manual driving apparatus 40 as an external output device, instead of being included in the remote manual driving apparatus 40. As the connection method, any method such as USB, HDMI®, or Bluetooth® can be used.

The controller 45 includes at least one processor, at least one programmable circuit, at least one dedicated circuit, or a combination of these. The controller 45 is communicably connected to each component included in the remote manual driving apparatus 40 and controls operations of the entire remote manual driving apparatus 40.

### Configuration of In-Vehicle Manual Driving Apparatus 50

In FIG. 1, for the purpose of simplifying the illustration, the configuration of the in-vehicle manual driving apparatus 50 is omitted, but the in-vehicle manual driving apparatus 50 has a configuration similar to that of the remote manual driving apparatus 40. For example, the in-vehicle manual driving apparatus 50 includes a communication interface, a memory, an input interface, an output interface, and a controller. The communication interface has a configuration similar to that of the communication interface 41. The memory has a configuration similar to that of the memory 42. The input interface has a configuration similar to that of the input interface 43. The output interface has a configuration similar to that of the output interface 44. The controller has a configuration similar to that of the controller 45.

### Contents of Evaluation Information

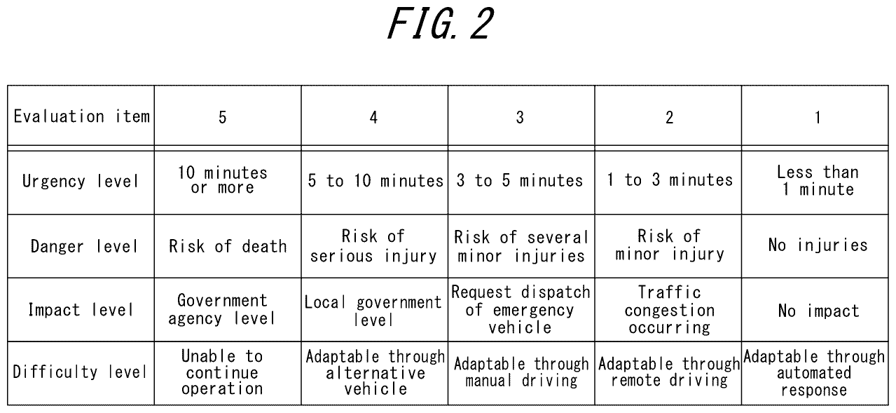

FIG. 2 is a table diagram illustrating a first example of the evaluation information generated by the determination apparatus 20 of the vehicle 10 of FIG. 1. With reference to FIG. 2, the first example of the contents of the evaluation information will be primarily explained. The first evaluation information illustrated in FIG. 2 includes, for example, an urgency level, a danger level, an impact level, and a difficulty level as evaluation items.

In the present disclosure, the “urgency level” is an evaluation item associated with estimated return time to operation by automated driving of the vehicle 10. The urgency level is, for example, the evaluation information based on measurement data from the second sensor, among the sensors 12A equipped in the vehicle 10. The urgency level is set to, for example, “1” when the estimated return time is less than 1 minute. The urgency level is set to, for example, “2” when the estimated return time is 1 minute or more and less than 3 minutes. The urgency level is set to, for example, “3” when the estimated return time is 3 minutes or more and less than 5 minutes. The urgency level is set to, for example, “4” when the estimated return time is 5 minutes or more and less than 10 minutes. The urgency level is set to, for example, “5” when the estimated return time is 10 minutes or more, or when return is not expected.

In the present disclosure, the “danger level” is an evaluation item classified according to, for example, the degree of injury risk to occupants of the vehicle 10. The danger level is, for example, the evaluation information based on measurement data from a camera, which is the first sensor among the sensors 12A equipped in the vehicle 10. The danger level is set to, for example, “1” when there are no injuries. The danger level is set to, for example, “2” when there is a risk of a minor injury. The danger level is set to, for example, “3” when there is a risk of several minor injuries. The danger level is set to, for example, “4” when there is a risk of a serious injury. The danger level is set to, for example, “5” when there is a risk of death.

In the present disclosure, the “impact level” is, for example, an evaluation item indicating the level of impact on society related to an ODD deviation of automated driving of the vehicle 10. The impact level is, for example, the evaluation information based on measurement data from a camera, which is the first sensor among the sensors 12A equipped in the vehicle 10. The impact level is set to, for example, “1” when there is no impact. The impact level is set to, for example, “2” when traffic congestion occurs around the vehicle 10. The impact level is set to, for example, “3” when an accident occurs involving the vehicle 10 itself or around the vehicle 10 and there is a request for the dispatch of an emergency vehicle. The “emergency vehicle” includes, for example, a fire truck, an ambulance, a vehicle of a rescue team, a police vehicle, or the like. The impact level is set to, for example, “4” when it is a situation that requires reporting to the local government, such as damage to public facilities. The “local government” includes, for example, police headquarters of each prefecture or any other agency at the prefectural level. The impact level is set to, for example, “5” when it is a situation that requires reporting to the government agency, such as the occurrence of a natural disaster. The “government agency” includes, for example, any agency at the national level.

In the present disclosure, the “difficulty level” is, for example, an evaluation item classified according to the possibility of responding by manual driving or the like in the event of an ODD deviation of automated driving of the vehicle 10. The difficulty level is, for example, the evaluation information based on measurement data from a camera, which is the first sensor, or from the second sensor among the sensors 12A equipped in the vehicle 10. The difficulty level is set to, for example, “1” when the vehicle 10 can adapt to the situation through an automated response. The difficulty level is set to, for example, “2” when the vehicle 10 can adapt to the situation through remote manual driving using the remote manual driving apparatus 40. The difficulty level is set to, for example, “3” when the vehicle 10 can adapt to the situation through manual driving inside the vehicle 10 using the in-vehicle manual driving apparatus 50. The difficulty level is set to, for example, “4” when the vehicle 10 can adapt to the situation through the deployment of an alternative vehicle. The difficulty level is set to, for example, “5” when the vehicle 10 or even an alternative vehicle cannot continue operation.

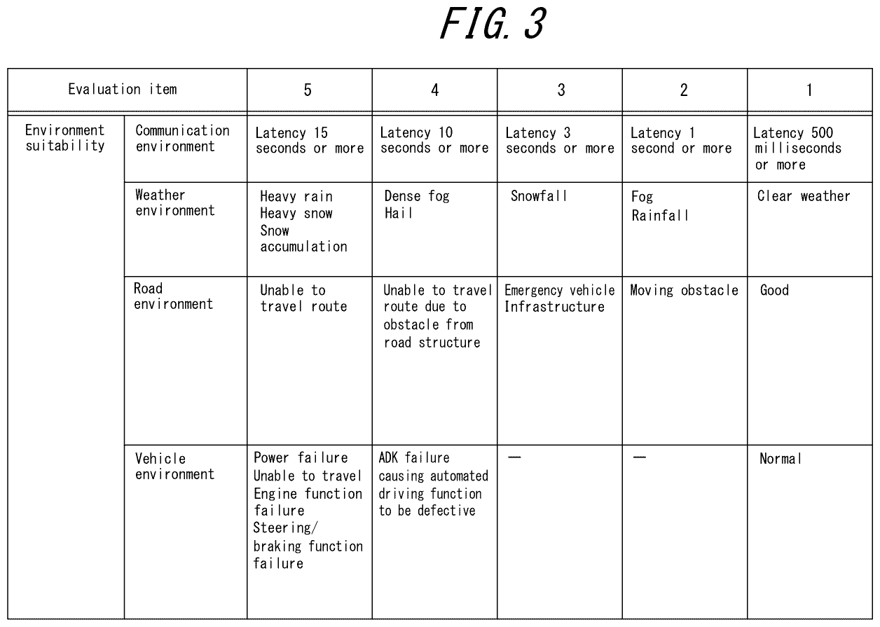

FIG. 3 is a table diagram illustrating a second example of the evaluation information generated by the determination apparatus 20 of the vehicle 10 of FIG. 1. With reference to FIG. 3, the second example of the contents of the evaluation information will be primarily explained. The second evaluation information illustrated in FIG. 3 includes, for example, environment suitability as evaluation items. “Environment” includes, for example, communication environment, weather environment, road environment, and vehicle environment.

In the present disclosure, the “communication environment” is an evaluation item associated with a wireless communication state, such as communication delay. The communication environment is, for example, the evaluation information based on measurement data from the second sensor among the sensors 12A equipped in the vehicle 10. The communication environment is set to, for example, “1” when the latency is 500 milliseconds or more and less than 1 second. The communication environment is set to, for example, “2” when the latency is 1 second or more and less than 3 seconds. The communication environment is set to, for example, “3” when the latency is 3 seconds or more and less than 10 seconds. The communication environment is set to, for example, “4” when the latency is 10 seconds or more and less than 15 seconds. The communication environment is set to, for example, “5” when the latency is 15 seconds or more.

In the present disclosure, the “weather environment” is an evaluation item associated with weather conditions such as rain, heavy rain, snowfall, heavy snowfall, snow accumulation, hail, fog, or dense fog. The weather environment is, for example, the evaluation information based on measurement data from a camera, which is the first sensor among the sensors 12A equipped in the vehicle 10. The weather environment is set to, for example, “1” when the weather condition is good. The weather environment is set to, for example, “2” when there is fog or rainfall. The weather environment is set to, for example, “3” when there is snowfall. The weather environment is set to, for example, “4” when there is dense fog or hail. The weather environment is set to, for example, “5” when there is heavy rain, heavy snowfall, or snow accumulation.

In the present disclosure, the “road environment” is an evaluation item associated with, for example, road conditions due to road structures, infrastructure such as signals, the passage of emergency vehicles, or other moving objects such as people or mobility. The road environment is, for example, the evaluation information based on measurement data from a camera, 3D-LiDAR, or a millimeter-wave sensor, which is the first sensor among the sensors 12A equipped in the vehicle 10. The road environment is set to, for example, “1” when the road conditions are good. The road environment is set to, for example, “2” when there is a moving obstacle such as a route obstruction by a person or mobility. The road environment is set to, for example, “3” when it is unable to travel the route due to the passage of an emergency vehicle or infrastructure such as a signal. The road environment is set to, for example, “4” when it is unable to travel the route due to an obstacle from a road structure. The road environment is set to, for example, “5” when it is unable to travel the route due to another significant reason.

In the present disclosure, the “vehicle environment” is an evaluation item associated with a vehicle state such as a power failure, unable to travel, an engine function failure, or a steering/braking function failure. The vehicle environment is, for example, the evaluation information based on measurement data from the second sensor among the sensors 12A equipped in the vehicle 10. The vehicle environment is set to, for example, “1” when the vehicle state is normal. The vehicle environment is set to, for example, “4” when there is a failure in the Autonomous Driving Kit (ADK) causing the automated driving function to be defective. The vehicle environment is set to, for example, “5” when there is a power failure, unable to travel, an engine function failure, or a steering/braking function failure.

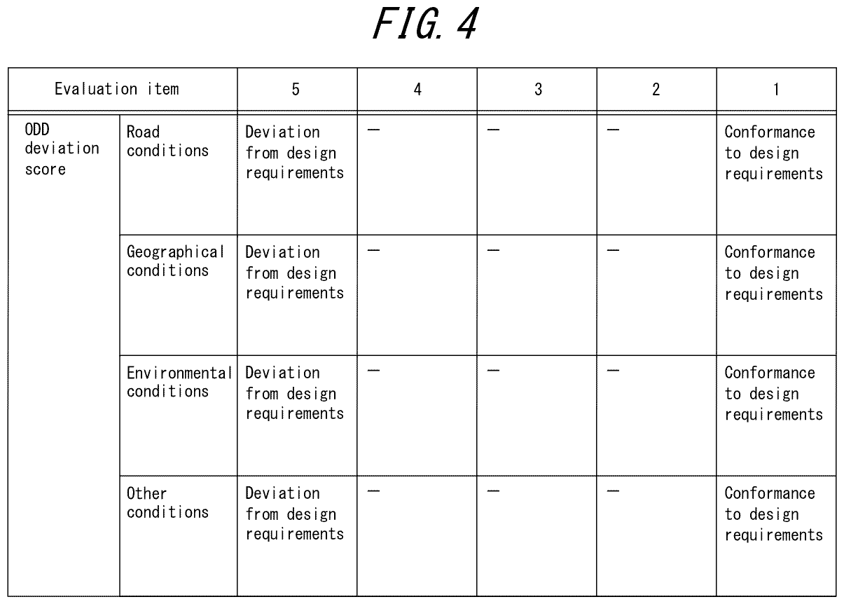

FIG. 4 is a table diagram illustrating a third example of the evaluation information generated by the determination apparatus 20 of the vehicle 10 of FIG. 1. With reference to FIG. 4, the third example of the contents of the evaluation information will be primarily explained. The third evaluation information illustrated in FIG. 4 includes, for example, ODD deviation scores as evaluation items. “ODD” includes, for example, road conditions, geographical conditions, environmental conditions, and other conditions.

In the present disclosure, the “road conditions” include, for example, the type of a road such as a closed area, a general road, a highway, or another automobile-exclusive road, the presence or absence of lanes, the number of lanes, the presence or absence of a sidewalk, a lane width, climbing performance, or the like. The road conditions are, for example, the evaluation information based on measurement data from a camera, 3D-LiDAR, a millimeter-wave sensor, or a GPS, which is the first sensor among the sensors 12A equipped in the vehicle 10. The road conditions are set to, for example, “1” when the road conditions conform to design requirements. The road conditions are set to, for example, “5” when the road conditions deviate from the design requirements.

In the present disclosure, the “geographical conditions” include, for example, conditions such as the presence or absence of a restriction on the range of a driving area. The geographical conditions are, for example, the evaluation information based on measurement data from a GPS, which is the first sensor among the sensors 12A equipped in the vehicle 10. The geographical conditions are set to, for example, “1” when the geographical conditions conform to design requirements. The geographical conditions are set to, for example, “5” when the geographical conditions deviate from the design requirements.

In the present disclosure, the “environmental conditions” include, for example, conditions such as the presence or absence of sunlight, rain or heavy rain, snow or accumulation of snow, or temperature. The environmental conditions are, for example, the evaluation information based on measurement data from a camera, which is the first sensor among the sensors 12A equipped in the vehicle 10. The environmental conditions are set to, for example, “1” when the environmental conditions conform to design requirements. The environmental conditions are set to, for example, “5” when the environmental conditions deviate from the design requirements.

In the present disclosure, “other conditions” include conditions such as a speed limit, signal information, the presence or absence of coordination with infrastructure, the presence or absence of the necessity of security personnel, or continuous driving time. The other conditions are the evaluation information based on measurement data from a camera, 3D-LiDAR, a millimeter-wave sensor, or a GPS, which is the first sensor, or the second sensor among the sensors 12A equipped in the vehicle 10. The other conditions are set to, for example, “1” when the other conditions conform to design requirements. The other conditions are set to, for example, “5” when the other conditions deviate from the design requirements.

### Contents of Skill Level

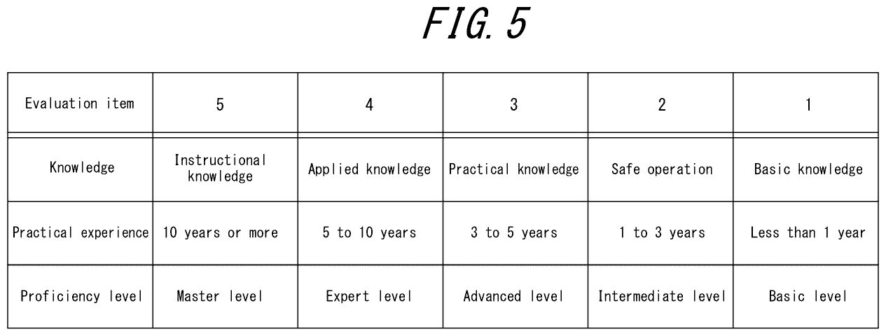

FIG. 5 is a table diagram illustrating an example of operations of the information processing apparatus 30 of FIG. 1. FIG. 5 illustrates evaluation items to determine the skill levels of operators who perform manual driving using the remote manual driving apparatus 40 or the in-vehicle manual driving apparatus 50. The evaluation items for the skill levels include, for example, knowledge, practical experience, and a proficiency level. In the present disclosure, the “skill level” refers to, for example, the level of proficiency in manual driving. The skill level is determined for each operator by a manager or the like of the operation management center 3, and is stored in advance in the memory 32 of the information processing apparatus 30 as a database associated with the operator's identification information.

The evaluation item “knowledge” is, for example, an evaluation item classified according to the operator's knowledge of manual driving. The skill level is set to “1” when the knowledge is at the level of basic knowledge based on laws and regulations. The skill level is set to “2” when the knowledge is sufficient for the safe operation of the vehicle 10. The skill level is set to “3” when the knowledge is at the level of practical knowledge regarding the operation of the vehicle 10. The skill level is set to “4” when the knowledge is at the level of applied knowledge regarding the operation of the vehicle 10. The skill level is set to “5” when the knowledge is at the level of instructional knowledge regarding the operation of the vehicle 10.

The evaluation item “practical experience” is, for example, an evaluation item classified according to the operator's practical experience in manual driving. The skill level is set to “1” when the practical experience is less than one year. The skill level is set to “2” when the practical experience is one year or more and less than three years. The skill level is set to “3” when the practical experience is 3 years or more and less than 5 years. The skill level is set to “4” when the practical experience is 5 years or more and less than 10 years. The skill level is set to “5” when the practical experience is 10 years or more.

The evaluation item “proficiency level” is, for example, an evaluation item classified according to the operator's proficiency in manual driving. The skill level is set to “1” when the proficiency level is at the basic level. The skill level is set to “2” when the proficiency level is at the intermediate level. The skill level is set to “3” when the proficiency level is at the advanced level. The skill level is set to “4” when the proficiency level is at the expert level. The skill level is set to “5” when the proficiency level is at the master level.

### Operation Flow of Information Processing System 1

Hereinafter, a flow of processes executed by the information processing system 1 when responding to an ODD deviation of the vehicle 10 will be primarily described.

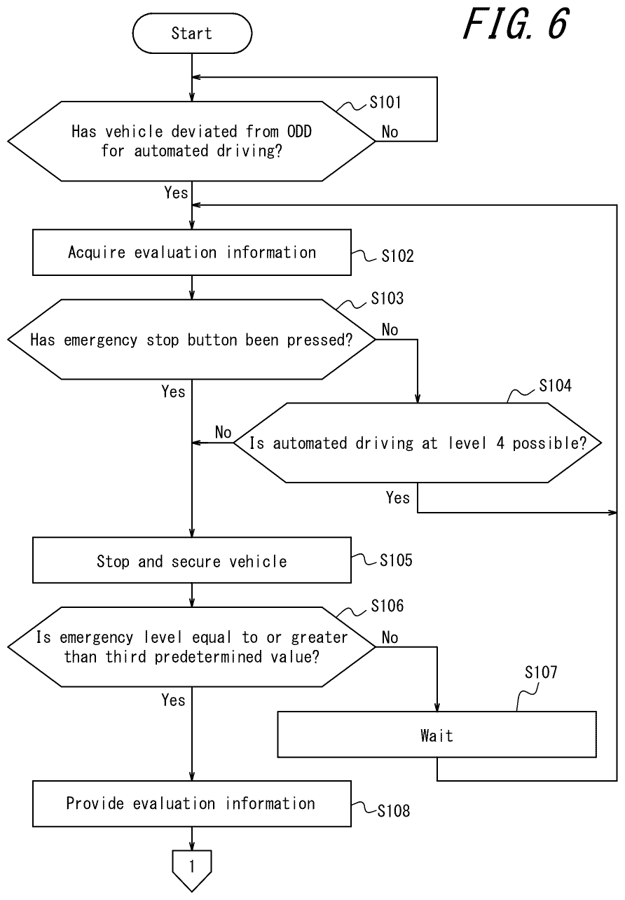

FIG. 6 is a first flowchart illustrating an example of an information processing method performed by the information processing system 1 of FIG. 1. FIG. 6 illustrates an example of a flow of processes executed by the determination apparatus 20 of the vehicle 10 that is executed at the onset of an ODD deviation of the vehicle 10.

In step S101, the controller 23 of the determination apparatus 20 of the vehicle 10 determines whether the vehicle 10 has deviated from the ODD of automated driving. Upon determining that the vehicle 10 has deviated from the ODD of automated driving, the controller 23 executes the process of step S102. Upon determining that the vehicle 10 has not deviated from the ODD of automated driving, the controller 23 re-executes the process from step S101.

In step S102, upon determining in step S101 that the vehicle 10 has deviated from the ODD of automated driving, the controller 23 of the determination apparatus 20 of the vehicle 10 starts an acquiring process of evaluation information. For example, the controller 23 acquires evaluation information based on measurement data from the sensors 12A of the measurement instruments 12 of the vehicle 10. The controller 23 generates each of first evaluation information, second evaluation information, and third evaluation information described above, and collectively acquires the first to third evaluation information as the evaluation information.

In step S103, the controller 23 of the determination apparatus 20 of the vehicle 10 determines whether an emergency stop button of the vehicle 10 has been pressed. For example, the emergency stop button may be installed in the interior of the vehicle 10 so as to be pressed by an occupant of the vehicle 10, or may be installed in the operation management center 3 so as to be pressed by a manager. Upon determining that the emergency stop button has been pressed, the controller 23 executes the process of step S105. Upon determining that the emergency stop button has not been pressed, the controller 23 executes the process of step S104.

In step S104, upon determining in step S103 that the emergency stop button has not been pressed, the controller 23 of the determination apparatus 20 of the vehicle 10 determines whether automated driving at Lv4 is possible for the vehicle 10.

For example, the controller 23 determines that automated driving at Lv4 is possible for the vehicle 10 when all of the evaluation items included in the first evaluation information, the second evaluation information, and the third evaluation information acquired in step S102 are “1”. Upon determining that automatic driving at Lv4 is possible, the controller 23 re-executes the process from step S102.

For example, when at least one of the evaluation items included in the first evaluation information, the second evaluation information, and the third evaluation information acquired in step S102 is “2” or higher, the controller 23 determines that automatic driving at Lv4 is not possible for the vehicle 10. Upon determining that automatic driving at Lv4 is not possible, the controller 23 executes the process of step S105.

In step S105, upon determining in step S103 that the emergency stop button has been pressed or upon determining in step S104 that automatic driving at Lv4 is not possible, the controller 23 of the determination apparatus 20 of the vehicle 10 stops and secures the vehicle 10.

For example, consider a case in which the emergency stop button is installed in the operation management center 3. The manager of the operation management center 3 resides at the operation management center 3, and while remotely monitoring information from the vehicle 10, determines whether the operation should be permitted or prohibited. The information processing system 1 has a mechanism that allows the vehicle 10 to be stopped and secured promptly when the manager determines that the operation of the vehicle 10 should be prohibited. For example, in a reflection of the intention of the manager residing in the operation management center 3, the controller 33 of the information processing apparatus 30 continuously transmits operation permission flag information to the vehicle 10. On the other hand, in a reflection of the intention of the manager, the controller 33 of the information processing apparatus 30 may stop and secure the vehicle 10 by ceasing the transmission of the operation permission flag information.

In step S106, the controller 23 of the determination apparatus 20 of the vehicle 10 determines whether the urgency level included in the evaluation information acquired in step S102 is equal to or greater than a third predetermined value. The third predetermined value may be, for example, “2.” Upon determining that the urgency level is equal to or greater than the third predetermined value, for example, “2,” the controller 23 executes the process of step S108. Upon determining that the urgency level is less than the third predetermined value, for example, upon determining that the urgency level is “1,” the controller 23 executes the process of step S107.

In step S107, upon determining in step S106 that the urgency level is less than the third predetermined value, the controller 23 of the determination apparatus 20 of the vehicle 10 waits, for example, until the vehicle 10 returns to operation through automatic driving.

In step S108, upon determining in step S106 that the urgency level is equal to or greater than the third predetermined value, the controller 23 of the determination apparatus 20 of the vehicle 10 provides the evaluation information acquired in step S102 to the information processing apparatus 30. For example, the controller 23 transmits the evaluation information acquired in step S102 to the information processing apparatus 30 via the communication interface 21 and the network 2. The controller 23 thereby executes a request for a response to the ODD deviation of the vehicle 10 to the operation management center 3.

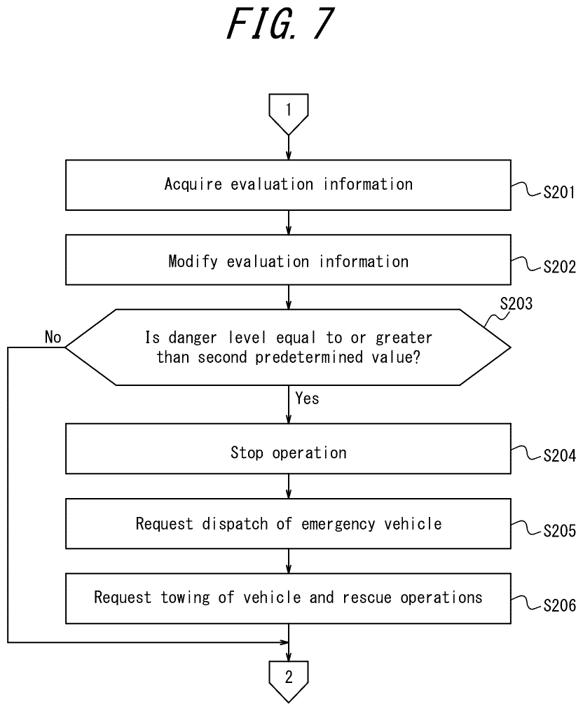

FIG. 7 is a second flowchart illustrating the example of the information processing method performed by the information processing system 1 of FIG. 1. FIG. 7 illustrates an example of a flow of processes executed by the information processing apparatus 30 following step S108 of FIG. 6 in the event of the ODD deviation of the vehicle 10.

In step S201, the controller 33 of the information processing apparatus 30 acquires the evaluation information based on measurement data from the sensors 12A equipped in the vehicle 10, which has an automated driving mode and a manual driving mode that allows manual driving by an operator. The controller 33 acquires, from the vehicle 10, the evaluation information acquired in step S102 of FIG. 6 by the determination apparatus 20 of the vehicle 10. For example, the controller 33 receives the evaluation information acquired in step S102 of FIG. 6 from the vehicle 10 via the network 2 and the communication interface 31. The controller 33 thereby accepts, from the vehicle 10, the request for a response to the ODD deviation of the vehicle 10.

In step S202, upon accepting, from the manager of the operation management center 3 that manages the operation of the vehicle 10, modification information for modifying the evaluation information acquired in step S201 from the vehicle 10, the controller 33 of the information processing apparatus 30 modifies the evaluation information based on the modification information. For example, the manager remotely checks the situation of the ODD deviation of the vehicle 10 using a monitor or the like, and inputs, as the modification information, a modification value for at least one evaluation item included in the evaluation information in the judgment of the manager in any method. The controller 33 acquires the input modification information in any method, and modifies the value of the at least one evaluation item included in the evaluation information to the modification value based on the acquired modification information.

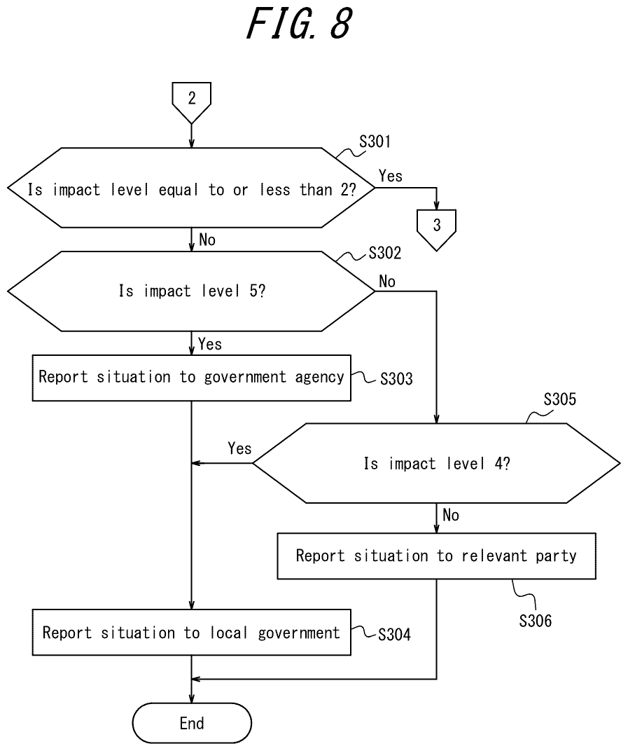

In step S203, the controller 33 of the information processing apparatus 30 determines whether the danger level included in the evaluation information is equal to or greater than a second predetermined value. The second predetermined value may be, for example, “2.” Upon determining that the danger level is equal to or greater than the second predetermined value, for example, “2,” the controller 33 executes the process of step S204. Upon determining that the danger level is less than the second predetermined value, for example, upon determining that the danger level is “1,” the controller 33 executes the process of step S301 in a third flowchart of FIG. 8.

The danger level used in step S203 may be, for example, a value that has been modified in step S202, or may be a value that has been acquired in step S201 without modification in step S202. The same applies to the following descriptions regarding other evaluation items included in the evaluation information.

In step S204, upon determining in step S203 that the danger level is equal to or greater than the second predetermined value, the controller 33 of the information processing apparatus 30 stops the operation of the vehicle 10.

In step S205, upon determining in step S203 that the danger level is equal to or greater than the second predetermined value, the controller 33 of the information processing apparatus 30 requests the dispatch of an emergency vehicle.

In step S206, in addition to the request for the dispatch of the emergency vehicle in step S205, the controller 33 of the information processing apparatus 30 requests the towing of the vehicle 10 by a tow truck and/or rescue operations by a rescue team. For example, the controller 33 requests both the towing of the vehicle 10 and the rescue operations.

FIG. 8 is a third flowchart illustrating the example of the information processing method performed by the information processing system 1 of FIG. 1. FIG. 8 illustrates an example of a flow of processes executed by the information processing apparatus 30 following step S206 of FIG. 7 in the event of the ODD deviation of the vehicle 10. The controller 33 of the information processing apparatus 30 reports the situation of the ODD deviation to the government agency and/or the local government according to the impact level included in the evaluation information.

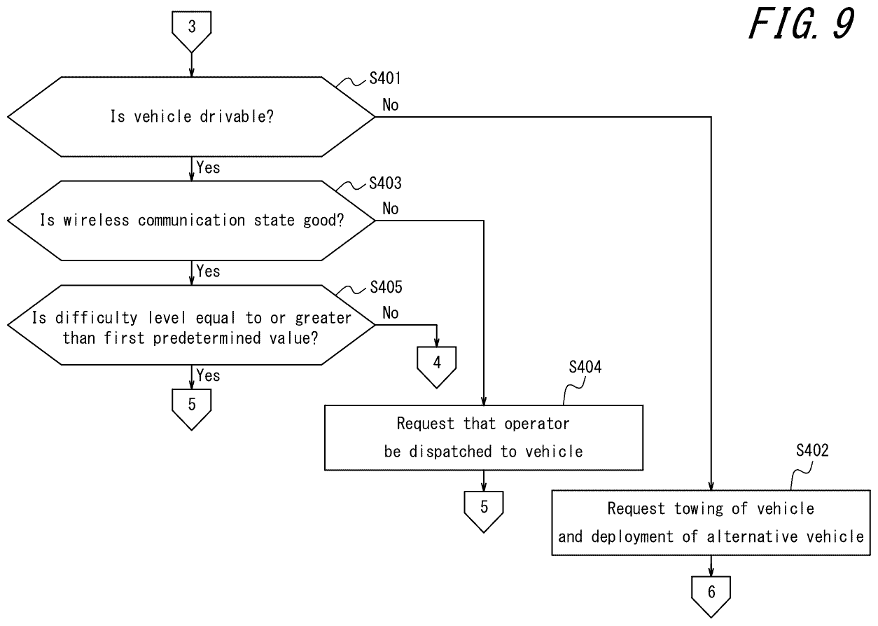

In step S301, the controller 33 of the information processing apparatus 30 determines whether the impact level included in the evaluation information is equal to or less than “2.” Upon determining that the impact level is equal to or less than “2,” the controller 33 executes the process of step S401 in a fourth flowchart of FIG. 9. Upon determining that the impact level is equal to or greater than “3,” the controller 33 executes the process of step S302.

In step S302, upon determining in step S301 that the impact level is equal to or greater than “3,” the controller 33 of the information processing apparatus 30 continuously determines whether the impact level is “5.” Upon determining that the impact level is “5,” the controller 33 executes the process of step S303. Upon determining that the impact level is “3” or “4,” the controller 33 executes the process of step S305.

In step S303, upon determining in step S302 that the impact level is “5,” the controller 33 of the information processing apparatus 30 reports the situation of the ODD deviation of the vehicle 10 to the government agency.

In step S304, in addition to the report to the government agency in step S303, the controller 33 of the information processing apparatus 30 reports the situation of the ODD deviation of the vehicle 10 to the local government.

In step S305, upon determining in step S302 that the impact level is “3” or “4,” the controller 33 of the information processing apparatus 30 continuously determines whether the impact level is “4.” Upon determining that the impact level is “4,” the controller 33 executes the process of step S304. Upon determining that the impact level is “3,” the controller 33 executes the process of step S306.

In step S306, upon determining in step S305 that the impact level is “3,” the controller 33 of the information processing apparatus 30 reports the situation of the ODD deviation of the vehicle 10 to the relevant party. The relevant party includes, for example, any agency that sends an emergency vehicle to the scene of the ODD deviation of the vehicle 10 upon accepting the report of the situation of the ODD deviation of the vehicle 10.

FIG. 9 is a fourth flowchart illustrating the example of the information processing method performed by the information processing system 1 of FIG. 1. FIG. 9 illustrates an example of a flow of processes executed by the information processing apparatus 30 following step S301 of FIG. 8 in the event of the ODD deviation of the vehicle 10.

In step S401, the controller 33 of the information processing apparatus 30 determines whether the vehicle 10 is drivable. For example, the controller 33 determines whether the vehicle 10 is drivable based on three evaluation items, i.e., the difficulty level included in the first evaluation information and the road environment and the vehicle environment included in the second evaluation information. Upon determining that the vehicle 10 is drivable, the controller 33 executes the process of step S403. Upon determining that the vehicle 10 is not drivable, the controller 33 executes the process of step S402.

In step S402, upon determining in step S401 that the vehicle 10 is not drivable, the controller 33 of the information processing apparatus 30 requests the towing of the vehicle 10 by a tow truck and/or the deployment of an alternative vehicle for the vehicle 10. For example, the controller 33 requests both the towing of the vehicle 10 and the deployment of an alternative vehicle.

In step S403, upon determining in step S401 that the vehicle 10 is drivable, the controller 33 of the information processing apparatus 30 determines whether the wireless communication state of the vehicle 10 is good, based on the communication environment and the vehicle environment of the vehicle 10 included in the evaluation information. Upon determining that the wireless communication state is good, the controller 33 executes the process of step S405. Upon determining that the wireless communication state is not good, the controller 33 executes the process of step S404.

In step S404, upon determining in step S403 that the wireless communication state is not good, the controller 33 of the information processing apparatus 30 requests that an operator who performs manual driving be dispatched to the vehicle 10. For example, the controller 33 requests the rescue team 4 to dispatch an operator to the vehicle 10.

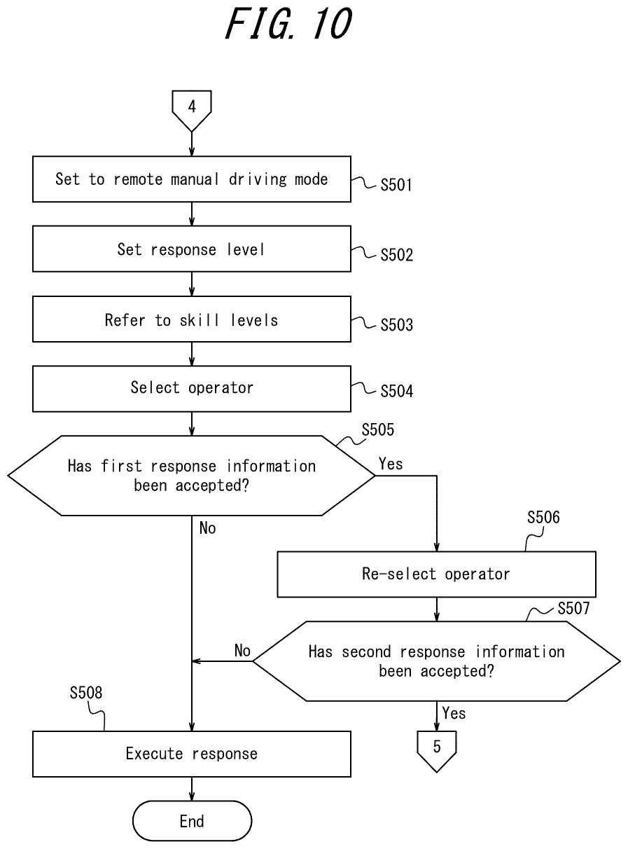

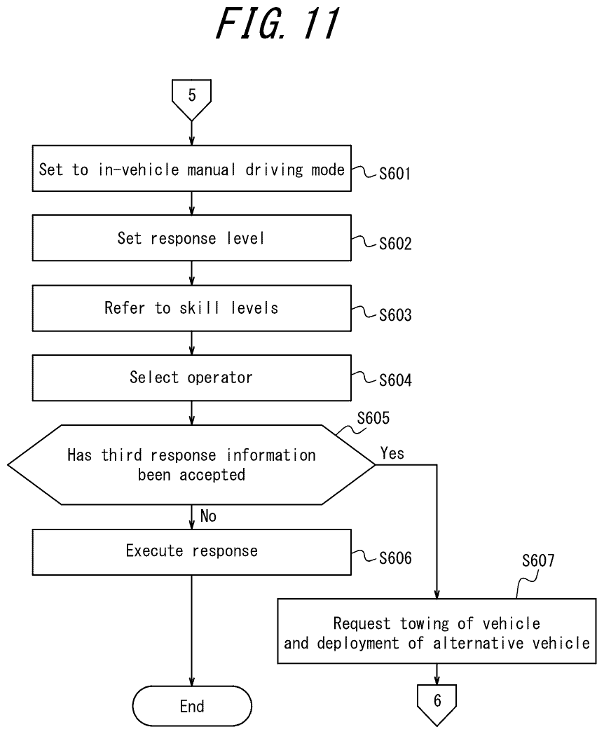

In step S405, upon determining in step S403 that the wireless communication state is good, the controller 33 of the information processing apparatus 30 determines whether the difficulty level of manual driving included in the evaluation information is equal to or greater than a first predetermined value. The first predetermined value may be, for example, “3.” Upon determining that the difficulty level is equal to or greater than the first predetermined value, for example, upon determining that the difficulty level is “3,” the controller 33 executes the process of step S601 in a sixth flowchart of FIG. 11. Upon determining that the difficulty level is less than the first predetermined value, for example, upon determining that the difficulty level is “2,” the controller 33 executes the process of step S501 in a fifth flowchart of FIG. 10.

Upon determining in step S403 that the wireless communication state of the vehicle 10 is good, the controller 33 of the information processing apparatus 30 executes a setting process of a response level and a selecting process of an operator of the vehicle 10, which will be described later. When the difficulty level of manual driving included in the evaluation information is equal to or greater than the first predetermined value, the controller 33 sets the in-vehicle manual driving mode as the manual driving mode, as illustrated in FIG. 11. When the difficulty level of manual driving included in the evaluation information is less than the first predetermined value, the controller 33 sets the remote manual driving mode as the manual driving mode, as illustrated in FIG. 10.

FIG. 10 is the fifth flowchart illustrating the example of the information processing method performed by the information processing system 1 of FIG. 1. FIG. 10 illustrates an example of a flow of processes in the information processing apparatus 30 when a setting process of a response level and a selecting process of an operator of the vehicle 10 are executed in the remote manual driving mode in the event of the ODD deviation of the vehicle 10.

In step S501, upon determining in step S405 of FIG. 9 that the difficulty level is relatively low, “2,” the controller 33 of the information processing apparatus 30 sets the manual driving mode of the vehicle 10 to the remote manual driving mode.

In step S502, the controller 33 of the information processing apparatus 30 sets a response level for manual driving based on the evaluation information when switching from the automated driving mode to the manual driving mode. For example, the controller 33 sets a response level in the remote manual driving mode using information on the communication environment, the weather environment, and the road environment of the vehicle 10 included in the second evaluation information. In the present disclosure, the “response level” may be the highest value of an evaluation item among the multiple evaluation items used for setting, the sum of the values of the multiple evaluation items, or a statistical value of the values of the multiple evaluation items. The “statistical value” includes, for example, an average, a median, or the like.

In step S503, the controller 33 of the information processing apparatus 30 refers to the skill levels of operators included in a database pre-stored in the memory 32.

In step S504, the controller 33 of the information processing apparatus 30 selects an operator who is allowed to perform manual driving of the vehicle 10 based on the response level set in step S502 and the skill level of the operator referenced in step S503. For example, the controller 33 selects an operator whose skill level is equal to or greater than the response level as the operator who is allowed to perform manual driving of the vehicle 10.

In step S505, the controller 33 of the information processing apparatus 30 determines whether first response information indicating that a response by manual driving is difficult has been accepted from the operator selected in step S504. For example, the operator remotely checks the situation of the ODD deviation of the vehicle 10 using the output interface 44 of the remote manual driving apparatus 40, and inputs information indicating that a response by manual driving is difficult in the judgment of the operator using the input interface 43 of the remote manual driving apparatus 40. Upon accepting the input information from the remote manual driving apparatus 40, the controller 33 determines that the first response information has been accepted. Upon determining that the first response information has been accepted, the controller 33 executes the process of step S506. Upon determining that the first response information has not been accepted, the controller 33 executes the process of step S508.

In step S506, upon determining in step S505 that the first response information indicating that a response by manual driving is difficult has been accepted from the selected operator, the controller 33 of the information processing apparatus 30 re-selects an operator with a higher skill level than the selected operator as the operator who is allowed to perform manual driving of the vehicle 10.

In step S507, the controller 33 of the information processing apparatus 30 determines whether second response information indicating that a response by manual driving is difficult has been accepted from the operator selected in step S506 in the remote manual driving mode. For example, the operator remotely checks the situation of the ODD deviation of the vehicle 10 using the output interface 44 of the remote manual driving apparatus 40, and inputs information indicating that a response by manual driving is difficult in the judgment of the operator using the input interface 43 of the remote manual driving apparatus 40. Upon accepting the input information from the remote manual driving apparatus 40, the controller 33 determines that the second response information has been accepted.

Upon determining that the second response information has been accepted, the controller 33 of the information processing apparatus 30 executes a series of processes in the sixth flowchart of FIG. 11. Upon accepting the second response information indicating that a response by manual driving is difficult from the operator selected in the remote manual driving mode, the controller 33 re-selects an operator who performs manual driving in the in-vehicle manual driving mode as the operator who is allowed to perform manual driving. Upon determining that the second response information has not been accepted, the controller 33 executes the process of step S508.

In step S508, upon determining in step S505 that the first response information has not been accepted or upon determining in step S507 that the second response information has not been accepted, the controller 33 of the information processing apparatus 30 execute the response. For example, the controller 33 may display a screen of the remote manual driving mode on the output interface 44 of the remote manual driving apparatus 40 so that the selected operator can manually drive the vehicle 10 in the remote manual driving mode.

FIG. 11 is the sixth flowchart illustrating the example of the information processing method performed by the information processing system 1 of FIG. 1. FIG. 11 illustrates an example of a flow of processes in the information processing apparatus 30 when a setting process of a response level and a selecting process of an operator of the vehicle 10 are executed in the in-vehicle manual driving mode in the event of the ODD deviation of the vehicle 10.

In step S601, upon determining in step S405 of FIG. 9 that the difficulty level is relatively high, “3,” or upon executing the process of step S404 of FIG. 9, the controller 33 of the information processing apparatus 30 sets the manual driving mode of the vehicle 10 to the in-vehicle manual driving mode.

In step S602, the controller 33 of the information processing apparatus 30 sets a response level for manual driving based on the evaluation information when switching from the automated driving mode to the manual driving mode. For example, the controller 33 sets a response level in the in-vehicle manual driving mode using information on the weather environment and the road environment of the vehicle 10 included in the second evaluation information. Thus, the controller 33 may set the response level using the evaluation information of different types in the in-vehicle manual driving mode and in the remote manual driving mode illustrated in FIG. 10.

In step S603, the controller 33 of the information processing apparatus 30 refers to the skill levels of operators included in a database re-stored in the memory 32.

In step S604, the controller 33 of the information processing apparatus 30 selects an operator who is allowed to perform manual driving of the vehicle 10 based on the response level set in step S602 and the skill level of the operator referenced in step S603. For example, the controller 33 selects an operator whose skill level is equal to or greater than the response level as the operator who is allowed to perform manual driving of the vehicle 10.

In step S605, the controller 33 of the information processing apparatus 30 determines whether third response information indicating that a response by manual driving is difficult has been accepted from the operator selected in step S604 in the in-vehicle manual driving mode. For example, the operator remotely checks the situation of the ODD deviation of the vehicle 10 using the output interface of the in-vehicle manual driving apparatus 50 or directly checks the situation by actually proceeding to the scene of the ODD deviation of the vehicle 10, and inputs information indicating that a response by manual driving is difficult in the judgment of the operator using the input interface of the in-vehicle manual driving apparatus 50. Upon accepting the input information from the in-vehicle manual driving apparatus 50, the controller 33 determines that the third response information has been accepted. Upon determining that the third response information has been accepted, the controller 33 executes the process of step S607. Upon determining that the third response information has not been accepted, the controller 33 executes the process of step S606.

In step S606, upon determining in step S605 that the third response information has not been accepted, the controller 33 of the information processing apparatus 30 execute the response. For example, the controller 33 may control a mobile vehicle of the rescue team 4 so that the selected operator can move to the scene of the vehicle 10 to directly and manually drive the vehicle 10 using the in-vehicle manual driving apparatus 50. For example, the controller 33 may guide the mobile vehicle to the scene of the vehicle 10 by automated driving, or display a movement route to the scene of the vehicle 10 on a monitor or the like installed in the interior of the mobile vehicle to assist the operator in driving the mobile vehicle to that scene.

In step S607, upon determining in step S605 that the third response information indicating that a response by manual driving is difficult has been accepted from the operator selected in the in-vehicle manual driving mode, the controller 33 of the information processing apparatus 30 requests the towing of the vehicle 10 and/or the deployment of an alternative vehicle for the vehicle 10. For example, the controller 33 requests both the towing of the vehicle 10 and the deployment of an alternative vehicle.

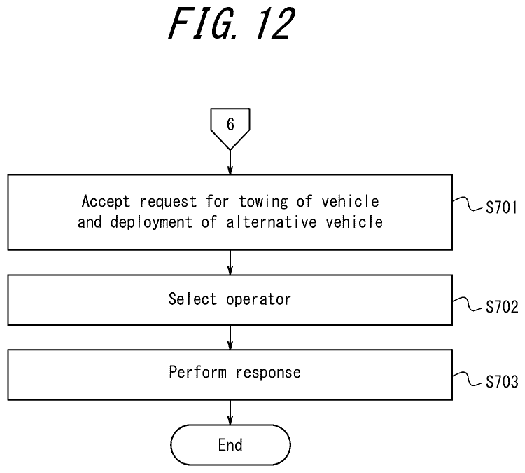

FIG. 12 is a seventh flowchart illustrating the example of the information processing method performed by the information processing system 1 of FIG. 1. FIG. 12 illustrates an example of a flow of processes executed by a server apparatus or a terminal apparatus on a management operator side that manages a tow truck for towing the vehicle 10 and/or an alternative vehicle for the vehicle 10. In the present disclosure, the “management operator” may be, for example, a business to which the rescue team 4 belongs, or another business unrelated to the rescue team 4.

In step S701, when the process of step S402 of FIG. 9 is executed or when the process of step S607 of FIG. 11 is executed, the apparatus on the management operator side accepts a request for the towing of the vehicle 10 and/or the deployment of an alternative vehicle for the vehicle 10. For example, the apparatus accepts requests for both the towing of the vehicle 10 and the deployment of an alternative vehicle.

In step S702, in response to the request accepted in step S701, the apparatus on the management operator side selects an operator to move the tow truck and/or the alternative vehicle to the scene of the vehicle 10.

In step S703, the apparatus on the management operator side causes the operator selected in step S702 to execute a response. For example, the apparatus may control the tow truck or the alternative vehicle so that the selected operator can move to the scene of the vehicle 10 to perform the necessary work. For example, the apparatus may guide the vehicle to the scene of the vehicle 10 by automated driving, or display a movement route to the scene of the vehicle 10 on a monitor or the like installed in the interior of the vehicle to assist the operator in driving the vehicle to that scene.

### Effects

The information processing apparatus 30 according to the above embodiment can improve technology for switching from automated driving to manual driving for the vehicle 10. The information processing apparatus 30 selects an operator who is allowed to perform manual driving of the vehicle 10 based on a response level and the skill level of the operator when switching from the automated driving mode to the manual driving mode. The information processing apparatus 30 can thereby assign an operator who can respond by manual driving according to the situation of an ODD deviation of the vehicle 10. The assigned operator can appropriately respond by manual driving to the situation of the ODD deviation of the vehicle 10.

For example, even when the operation management center 3 manages the automated operation of multiple vehicles 10, the information processing apparatus 30 can appropriately assign, for each situation, an operator who responds by remote manual driving or in-vehicle manual driving for a vehicle 10 that has deviated from the ODD. Even in the event that multiple response requests occur simultaneously at a large-scale operation management center 3, the information processing apparatus 30 can efficiently assign an operator for each request.

The information processing apparatus 30 selects an operator whose skill level is equal to or greater than a response level, as an operator who is allowed to perform manual driving. This allows the information processing apparatus 30 to assign an operator who can more appropriately respond to the situation of an ODD deviation of the vehicle 10.

Upon accepting first response information from the selected operator, the information processing apparatus 30 re-selects an operator with a higher skill level than the selected operator, as the operator who is allowed to perform manual driving. This allows the information processing apparatus 30 to newly assign an operator who can more appropriately respond to the situation of the ODD deviation of the vehicle 10.

The information processing apparatus 30 sets the in-vehicle manual driving mode when the difficulty level is equal to or greater than a first predetermined value, and sets the remote manual driving mode when the difficulty level is less than the first predetermined value. This allows the information processing apparatus 30 to set the in-vehicle manual driving mode for situations that are considered more difficult to respond to. The information processing apparatus 30 can have an operator directly perform manual driving of the vehicle 10 at the scene of an ODD deviation of the vehicle 10, and therefore have the operator respond to the situation of the ODD deviation of the vehicle 10 more appropriately.

Upon accepting second response information from an operator selected in the remote manual driving mode, the information processing apparatus 30 re-selects an operator to perform manual driving in the in-vehicle manual driving mode. Therefore, even in situations in which a response in the remote manual driving mode is difficult, the information processing apparatus 30 can have an operator directly perform manual driving of the vehicle 10 at the scene of an ODD deviation of the vehicle 10, and therefore have the operator respond to the situation of the ODD deviation of the vehicle 10 more appropriately.

Upon accepting third response information from an operator selected in the in-vehicle manual driving mode, the information processing apparatus 30 requests the towing of the vehicle 10 and/or the deployment of an alternative vehicle for the vehicle 10. This allows the information processing apparatus 30 to respond to the situation of an ODD deviation of the vehicle 10 with alternative measures such as the towing of the vehicle 10 or the deployment of an alternative vehicle for the vehicle 10, even when the operator is difficult to respond by manual driving of the vehicle 10.

The information processing apparatus 30 sets a response level using evaluation information of different types in the in-vehicle manual driving mode and in the remote manual driving mode. This allows the information processing apparatus 30 to set the response level appropriately according to each mode.

Upon accepting, from a manager of the operation management center 3, modification information for modifying evaluation information acquired from the vehicle 10, the information processing apparatus 30 modifies the evaluation information based on the modification information. This allows the manager of the operation management center 3 to modify the numerical values of respective evaluation items included in the evaluation information to more appropriate values based on rich experience, judgment, and the like. Consequently, the information processing apparatus 30 can also improve the accuracy of the evaluation information.

The information processing apparatus 30 requests the dispatch of an emergency vehicle when the danger level included in the evaluation information is equal to or greater than a second predetermined value. This allows the information processing apparatus 30 to appropriately respond to situations in which the risk of injury to occupants of the vehicle 10 is high.

The information processing apparatus 30 reports the situation of an ODD deviation to the government agency and/or the local government according to the impact level included in the evaluation information. This allows the information processing apparatus 30 to transmit necessary information to the appropriate agency according to the level of impact on society related to the ODD deviation of the automated driving of the vehicle 10.

Upon determining that the wireless communication state of the vehicle 10 is good, the information processing apparatus 30 executes a setting process of a response level and a selecting process of an operator. This allows the information processing apparatus 30 to execute the setting process of a response level and the selecting process of an operator described above while confirming that the communication connection between the operation management center 3 and the vehicle 10 is established.

Upon determining that the wireless communication state is not good, the information processing apparatus 30 requests that an operator who performs manual driving be dispatched to the vehicle 10. Therefore, even in a situation in which the communication connection between the operation management center 3 and the vehicle 10 is not established, the information processing apparatus 30 can have an operator directly perform manual driving of the vehicle 10 at the scene of an ODD deviation of the vehicle 10, and therefore have the operator respond to the situation of the ODD deviation of the vehicle 10 appropriately.

The vehicle 10 provides evaluation information to the information processing apparatus 30 when the urgency level included in the evaluation information is equal to or greater than a third predetermined value. This allows the vehicle 10 to provide the evaluation information to the information processing apparatus 30 only when the urgency level is high. Therefore, the information processing apparatus 30 can accept a request for a response only when the urgency level is high, and can execute a series of processes related to the response. As a result, the information processing apparatus 30 can reduce a processing load.

### Variations

While the present disclosure has been described based on the drawings and examples, it should be noted that various changes and modifications can be made by those skilled in the art based on the present disclosure. Accordingly, such modifications and revisions are included within the scope of the present disclosure. For example, functions or the like included in each configuration, each step, or the like can be rearranged without logical inconsistency, and a plurality of configurations, steps, or the like can be combined into one or divided.

For example, a configuration that causes a general purpose electronic device such as a smartphone or a computer to function as each apparatus of the information processing system 1 according to the above embodiment is also possible. Specifically, a program in which processes for realizing the functions of the information processing apparatus 30 or the like according to the embodiment are written may be stored in a memory of the electronic device, and the program may be read and executed by a processor of the electronic device. Accordingly, the present disclosure can also be implemented as a program executable by a processor.

Alternatively, the present disclosure can also be implemented as a non-transitory computer readable medium storing a program executable by a single processor or a plurality of processors to cause the information processing apparatus 30 or the like according to the embodiment to execute the functions. It is to be understood that these are also included within the scope of the present disclosure.

For example, at least a portion of the processing operations executed in the information processing apparatus 30 in the above embodiment may be executed in the vehicle 10, the determination apparatus 20, the remote manual driving apparatus 40, and/or the in-vehicle manual driving apparatus 50. At least a portion of the processing operations executed in the vehicle 10, the determination apparatus 20, the remote manual driving apparatus 40, and/or the in-vehicle manual driving apparatus 50 may be executed in the information processing apparatus 30.

In addition to the processing in the above embodiment, the controller 33 of the information processing apparatus 30 may identify an operator who is attempting to operate the manual driving apparatus of the vehicle 10, and when the skill level of the identified operator does not meet a response level, the controller 33 of the information processing apparatus 30 may determine that the operator is not the operator who is allowed to perform the manual driving. In the present disclosure, the “manual driving apparatus” may include the remote manual driving apparatus 40 or the in-vehicle manual driving apparatus 50.

For example, the controller 33 may identify the operator using an imaging module or a biometric authentication module included in the input interface 43 of the remote manual driving apparatus 40. The controller 33 may read the skill level associated with the identification information on the identified operator from the database stored in the memory 32, and compare the skill level with the response level. The same applies to the in-vehicle manual driving apparatus 50. Upon determining that the operator is not the operator who is allowed to perform the manual driving, the controller 33 may lock the functions of the manual driving apparatus and control the manual driving apparatus so that manual driving of the vehicle 10 becomes impossible.

Through the above processing, the information processing apparatus 30 can identify an individual attempting to operate the manual driving apparatus of the vehicle 10 and easily determine whether the individual is an authorized person. The information processing apparatus 30 can prevent unauthorized people from manually driving the vehicle 10, thereby avoiding hijacking of the vehicle 10 and improving security. As a result, the information processing apparatus 30 can also ensure the safety of occupants of the vehicle 10.

Additionally, the information processing apparatus 30 can detect an operator's poor health conditions using, for example, an imaging module or a biometric authentication module of the manual driving apparatus. Upon determining that it is difficult for the operator to continue manual driving due to poor health conditions or the like, the information processing apparatus 30 may stop and secure the vehicle 10. As a result, the information processing apparatus 30 can avoid situations in which driving operations by the operator are not performed normally, and occupants of the vehicle 10 are put at risk.

In the above embodiment, the information processing apparatus 30 has been described as selecting an operator whose skill level is equal to or greater than a response level as an operator who is allowed to perform manual driving, but is not limited to this. In some cases, the information processing apparatus 30 may select an operator whose skill level is less than the response level, as the operator who is allowed to perform manual driving.

In the above embodiment, the information processing apparatus 30 has been described as accepting first response information indicating that a response by manual driving is difficult from the selected operator, but is not limited to this. The information processing apparatus 30 may not accept the first response information. The information processing apparatus 30 has been described, upon accepting the first response information, as re-selecting an operator with a higher skill level than the selected operator, as the operator who is allowed to perform manual driving, but is not limited to this. The information processing apparatus 30 may not execute such a re-selecting process.

In the above embodiment, the information processing apparatus 30 has been described as setting the in-vehicle manual driving mode when the difficulty level is equal to or greater than a first predetermined value, and setting the remote manual driving mode when the difficulty level is less than the first predetermined value, but is not limited to this. The information processing apparatus 30 may execute a similar setting process based on another evaluation item included in the evaluation information, instead of or in addition to the difficulty level.

In the above embodiment, the information processing apparatus 30 has been described as accepting second response information indicating that a response by manual driving is difficult from an operator selected in the remote manual driving mode, but is not limited to this. The information processing apparatus 30 may not accept the second response information. The information processing apparatus 30 has been described, upon accepting the second response information, as re-selecting an operator who performs manual driving in the in-vehicle manual driving mode, as the operator who is allowed to perform manual driving, but is not limited to this. The information processing apparatus 30 may not execute such a re-selecting process.

In the above embodiment, the information processing apparatus 30 has been described as accepting third response information indicating that a response by manual driving is difficult from the operator selected in the in-vehicle manual driving mode, but is not limited to this. The information processing apparatus 30 may not accept the third response information. The information processing apparatus 30 has been described, upon accepting the third response information, as requesting the towing of the vehicle 10 and/or the deployment of an alternative vehicle for the vehicle 10, but is not limited to this. The information processing apparatus 30 may not execute such a request process.

In the above embodiment, the information processing apparatus 30 has been described as setting a response level using evaluation information of different types in the in-vehicle manual driving mode and in the remote manual driving mode, but is not limited to this. The information processing apparatus 30 may set the response level using the evaluation information of the same type in the in-vehicle manual driving mode and in the remote manual driving mode.

In the above embodiment, the information processing apparatus 30 has been described as setting a response level in the remote manual driving mode, using information on the communication environment, the weather environment, and the road environment of the vehicle 10 included in the evaluation information, but is not limited to this. The information processing apparatus 30 may set the response level in the remote manual driving mode using another evaluation item included in the evaluation information, instead of or in addition to the communication environment, the weather environment, and/or the road environment.

In the above embodiment, the information processing apparatus 30 has been described as setting a response level in the in-vehicle manual driving mode using information on the weather environment and the road environment of the vehicle 10 included in the evaluation information, but is not limited to this. The information processing apparatus 30 may set the response level in the in-vehicle manual driving mode using another evaluation item included in the evaluation information, instead of or in addition to the weather environment and/or the road environment.

In the above embodiment, the information processing apparatus 30 has been described as accepting, from a manager of the operation management center 3, modification information for modifying evaluation information acquired from the vehicle 10, but is not limited to this. The information processing apparatus 30 may not accept the modification information. The information processing apparatus 30 has been described as modifying the evaluation information based on the modification information, but is not limited to this. The information processing apparatus 30 may not execute a modification process of the evaluation information.

In the above embodiment, the information processing apparatus 30 has been described as requesting the dispatch of an emergency vehicle when the danger level is equal to or greater than a second predetermined value, but is not limited to this. The information processing apparatus 30 may execute a similar request process based on another evaluation item included in the evaluation information, instead of or in addition to the danger level. Alternatively, the information processing apparatus 30 may not execute the process to request the dispatch of the emergency vehicle.

In the above embodiment, the information processing apparatus 30 has been described as reporting the situation of an ODD deviation to the government agency and/or the local government according to the impact level, but is not limited to this. The information processing apparatus 30 may execute a similar report process based on another evaluation item included in the evaluation information, instead of or in addition to the impact level. Alternatively, the information processing apparatus 30 may not execute the process to report the situation of the ODD deviation.

In the above embodiment, the information processing apparatus 30 has been described, upon determining that the wireless communication state of the vehicle 10 is good based on the communication environment and the vehicle environment, as executing a setting process of a response level and a selecting process of an operator, but is not limited to this. The information processing apparatus 30 may determine the wireless communication state of the vehicle 10 based on another evaluation item included in the evaluation information, instead of or in addition to the communication environment and/or the vehicle environment. Alternatively, the information processing apparatus 30 may not execute the determination process of the wireless communication state of the vehicle 10, before executing the setting process of the response level and the selecting process of the operator.

In the above embodiment, the information processing apparatus 30 has been described, upon determining that the wireless communication state is not good, as requesting that an operator who performs manual driving be dispatched to the vehicle 10, but is not limited to this. The information processing apparatus 30 may not execute such a request process.

In the above embodiment, the vehicle 10 has been described as providing evaluation information to the information processing apparatus 30 when the urgency level is equal to or greater than a third predetermined value, but is not limited to this. The vehicle 10 may execute a similar provision process based on another evaluation item included in the evaluation information, instead of or in addition to the urgency level. Alternatively, the vehicle 10 may not execute the process to provide the evaluation information to the information processing apparatus 30. For example, the vehicle 10 may provide only the measurement data from the sensors 12A to the information processing apparatus 30. At this time, the information processing apparatus 30 may generate and acquire evaluation information based on the measurement data acquired from the vehicle 10.

In the above embodiment, the vehicle 10 has been described, upon determining a deviation from the ODD of automated driving, as starting an acquiring process of evaluation information, but is not limited to this. The vehicle 10 may start the acquiring process of the evaluation information based on any other process, instead of or in addition to the determination process regarding the deviation of the ODD of automated driving.

In the above embodiment, the operation management center 3 has been described as having one remote manual driving apparatus 40, but is not limited to this. When an operation area is extensive, the operation management center 3 may have multiple remote manual driving apparatuses 40 for each area. The remote manual driving apparatus 40 may be installed in a rescue center in which the rescue team 4 is on standby.

In the above embodiment, the vehicle 10 equipped with the determination apparatus 20 has been described as an automobile, but is not limited to this. The determination apparatus 20 may be mounted on other mobility, such as an autonomously navigating motorboat or drone.

In the above embodiment, the vehicle 10 has been described as including an automobile with the Lv4 automated driving function, but is not limited to this. The vehicle 10 may include an automobile with an automated driving function at an level other than Lv4, or an automobile that is driven by a regular driver.

In the above embodiment, the vehicle 10 has been described as being temporarily provided with the in-vehicle manual driving apparatus 50, without a mechanical operation unit for manual driving, but is not limited to this. The vehicle 10 may be, for example, an automobile with the Lv4 automated driving function, or may have a driver's seat with a mechanical operation unit permanently installed.

Examples of some embodiments of the present disclosure are described below. However, it should be noted that the embodiments of the present disclosure are not limited to these examples.

[Appendix 1] An information processing apparatus comprising a controller configured to:

acquire evaluation information based on measurement data from a sensor provided in a vehicle that has an automated driving mode and a manual driving mode capable of manual driving by an operator;

when switching from the automated driving mode to the manual driving mode, set a response level for the manual driving based on the evaluation information; and

select an operator who is allowed to perform the manual driving of the vehicle, based on the response level and a skill level of the operator.

[Appendix 2] The information processing apparatus according to appendix 1, wherein the controller is configured to select an operator whose skill level is equal to or greater than the response level, as the operator who is allowed to perform the manual driving.

[Appendix 3] The information processing apparatus according to appendix 1 or 2, wherein the controller is configured to, upon accepting first response information from the selected operator, re-select an operator with a higher skill level than the selected operator, as the operator who is allowed to perform the manual driving.

[Appendix 4] The information processing apparatus according to any one of appendices 1 to 3, wherein the controller is configured to:

identify an operator who is attempting to operate the vehicle's manual driving apparatus to be used for the manual driving; and

when a skill level of the identified operator does not meet the response level, determine that the identified operator does not coincide with the operator who is allowed to perform the manual driving.

[Appendix 5] The information processing apparatus according to any one of appendices 1 to 4, wherein the controller is configured to:

set, as the manual driving mode, an in-vehicle manual driving mode in which the manual driving is performed inside the vehicle when a difficulty level of the manual driving included in the evaluation information is equal to or greater than a first predetermined value; and

set, as the manual driving mode, a remote manual driving mode in which the manual driving is performed outside the vehicle when the difficulty level is less than the first predetermined value.

[Appendix 6] The information processing apparatus according to appendix 5, wherein the controller is configured to, upon accepting second response information from the operator selected in the remote manual driving mode, re-select an operator who performs the manual driving in the in-vehicle manual driving mode, as the operator who is allowed to perform the manual driving.

[Appendix 7] The information processing apparatus according to appendix 5 or 6, wherein the controller is configured to, upon accepting third response information from the operator selected in the in-vehicle manual driving mode, request towing of the vehicle and/or deployment of an alternative vehicle for the vehicle.

[Appendix 8] The information processing apparatus according to any one of appendices 5 to 7, wherein the controller is configured to set the response level using the evaluation information of different types in the in-vehicle manual driving mode and in the remote manual driving mode.

[Appendix 9] The information processing apparatus according to appendix 8, wherein the controller is configured to set the response level in the remote manual driving mode using information on the vehicle's communication environment, weather environment, and road environment included in the evaluation information.

[Appendix 10] The information processing apparatus according to appendix 8 or 9, wherein the controller is configured to set the response level in the in-vehicle manual driving mode using information on the vehicle's weather environment and road environment included in the evaluation information.

[Appendix 11] The information processing apparatus according to any one of appendices 1 to 10, wherein the controller is configured to modify the evaluation information acquired from the vehicle based on modification information for modifying the evaluation information, upon accepting the modification information from a manager of an operation management center that manages an operation of the vehicle.

[Appendix 12] The information processing apparatus according to any one of appendices 1 to 11, wherein the controller is configured to request dispatch of an emergency vehicle when a danger level that is included in the evaluation information and that is classified according to a degree of injury risk to an occupant of the vehicle is equal to or greater than a second predetermined value.

[Appendix 13] The information processing apparatus according to any one of appendices 1 to 12, wherein the controller is configured to report a situation of an ODD deviation of automated driving of the vehicle to a government agency and/or a local government according to an impact level that is included in the evaluation information and that indicates a level of impact on society related to the ODD deviation.

[Appendix 14] The information processing apparatus according to any one of appendices 1 to 13, wherein the controller is configured to perform a setting process of the response level and a selecting process of the operator, upon determining that the vehicle's wireless communication state is good based on the vehicle's communication environment and vehicle environment included in the evaluation information.

[Appendix 15] The information processing apparatus according to appendix 14, wherein the controller is configured to request that the operator who performs the manual driving be dispatched to the vehicle, upon determining that the wireless communication state is not good.

[Appendix 16] An information processing system comprising:

the information processing apparatus according to any one of appendices 1 to 15; and

the vehicle configured to:
acquire the measurement data using the sensor; and
acquire the evaluation information based on the acquired measurement data, and provide the evaluation information to the information processing apparatus.

[Appendix 17] An information processing method performed by an information processing apparatus, the information processing method comprising:

acquiring evaluation information based on measurement data from a sensor provided in a vehicle that has an automated driving mode and a manual driving mode capable of manual driving by an operator;

when switching from the automated driving mode to the manual driving mode, setting a response level for the manual driving based on the evaluation information; and

selecting an operator who is allowed to perform the manual driving of the vehicle, based on the response level and a skill level of the operator.

[Appendix 18] A vehicle configured with an automated driving mode and a manual driving mode capable of manual driving by an operator, the vehicle comprising:

a sensor; and

a controller configured to acquire evaluation information based on measurement data from the sensor,

wherein when switching from the automated driving mode to the manual driving mode, the controller is configured to set a response level for the manual driving based on the evaluation information, and provide the evaluation information to an information processing apparatus that selects an operator who is allowed to perform the manual driving of the vehicle, based on the response level and a skill level of the operator.

[Appendix 19] The vehicle according to appendix 18, wherein the controller is configured to provide the evaluation information to the information processing apparatus when an urgency level that is included in the evaluation information and that corresponds to estimated return time to an operation by automated driving of the vehicle is equal to or greater than a third predetermined value.

[Appendix 20] The vehicle according to appendix 18 or 19, wherein the controller is configured to start an acquiring process of the evaluation information upon determining that the vehicle has deviated from an ODD for automated driving.

1. An information processing apparatus comprising a controller configured to:
acquire evaluation information based on measurement data from a sensor provided in a vehicle that has an automated driving mode and a manual driving mode capable of manual driving by an operator;
when switching from the automated driving mode to the manual driving mode, set a response level for the manual driving based on the evaluation information; and
select an operator who is allowed to perform the manual driving of the vehicle, based on the response level and a skill level of the operator.

2. The information processing apparatus according to claim 1, wherein the controller is configured to select an operator whose skill level is equal to or greater than the response level, as the operator who is allowed to perform the manual driving.

3. The information processing apparatus according to claim 1, wherein the controller is configured to, upon accepting first response information from the selected operator, re-select an operator with a higher skill level than the selected operator, as the operator who is allowed to perform the manual driving.

4. The information processing apparatus according to claim 1, wherein the controller is configured to:
identify an operator who is attempting to operate the vehicle's manual driving apparatus to be used for the manual driving; and
when a skill level of the identified operator does not meet the response level, determine that the identified operator does not coincide with the operator who is allowed to perform the manual driving.

5. The information processing apparatus according to claim 1, wherein the controller is configured to:
set, as the manual driving mode, an in-vehicle manual driving mode in which the manual driving is performed inside the vehicle when a difficulty level of the manual driving included in the evaluation information is equal to or greater than a first predetermined value; and
set, as the manual driving mode, a remote manual driving mode in which the manual driving is performed outside the vehicle when the difficulty level is less than the first predetermined value.

6. The information processing apparatus according to claim 5, wherein the controller is configured to, upon accepting second response information from the operator selected in the remote manual driving mode, re-select an operator who performs the manual driving in the in-vehicle manual driving mode, as the operator who is allowed to perform the manual driving.

7. The information processing apparatus according to claim 5, wherein the controller is configured to, upon accepting third response information from the operator selected in the in-vehicle manual driving mode, request towing of the vehicle and/or deployment of an alternative vehicle for the vehicle.

8. The information processing apparatus according to claim 5, wherein the controller is configured to set the response level using the evaluation information of different types in the in-vehicle manual driving mode and in the remote manual driving mode.

9. The information processing apparatus according to claim 8, wherein the controller is configured to set the response level in the remote manual driving mode using information on the vehicle's communication environment, weather environment, and road environment included in the evaluation information.

10. The information processing apparatus according to claim 8, wherein the controller is configured to set the response level in the in-vehicle manual driving mode using information on the vehicle's weather environment and road environment included in the evaluation information.

11. The information processing apparatus according to claim 1, wherein the controller is configured to modify the evaluation information acquired from the vehicle based on modification information for modifying the evaluation information, upon accepting the modification information from a manager of an operation management center that manages an operation of the vehicle.

12. The information processing apparatus according to claim 1, wherein the controller is configured to request dispatch of an emergency vehicle when a danger level that is included in the evaluation information and that is classified according to a degree of injury risk to an occupant of the vehicle is equal to or greater than a second predetermined value.

13. The information processing apparatus according to claim 1, wherein the controller is configured to report a situation of an ODD deviation of automated driving of the vehicle to a government agency and/or a local government according to an impact level that is included in the evaluation information and that indicates a level of impact on society related to the ODD deviation.

14. The information processing apparatus according to claim 1, wherein the controller is configured to perform a setting process of the response level and a selecting process of the operator, upon determining that the vehicle's wireless communication state is good based on the vehicle's communication environment and vehicle environment included in the evaluation information.

15. The information processing apparatus according to claim 14, wherein the controller is configured to request that the operator who performs the manual driving be dispatched to the vehicle, upon determining that the wireless communication state is not good.

16. An information processing system comprising:
the information processing apparatus according to claim 1; and
the vehicle configured to:
acquire the measurement data using the sensor; and
acquire the evaluation information based on the acquired measurement data, and provide the evaluation information to the information processing apparatus.

17. An information processing method performed by an information processing apparatus, the information processing method comprising:
acquiring evaluation information based on measurement data from a sensor provided in a vehicle that has an automated driving mode and a manual driving mode capable of manual driving by an operator;
when switching from the automated driving mode to the manual driving mode, setting a response level for the manual driving based on the evaluation information; and
selecting an operator who is allowed to perform the manual driving of the vehicle, based on the response level and a skill level of the operator.

18. A vehicle configured with an automated driving mode and a manual driving mode capable of manual driving by an operator, the vehicle comprising:
a sensor; and
a controller configured to acquire evaluation information based on measurement data from the sensor,
wherein when switching from the automated driving mode to the manual driving mode, the controller is configured to set a response level for the manual driving based on the evaluation information, and provide the evaluation information to an information processing apparatus that selects an operator who is allowed to perform the manual driving of the vehicle, based on the response level and a skill level of the operator.

19. The vehicle according to claim 18, wherein the controller is configured to provide the evaluation information to the information processing apparatus when an urgency level that is included in the evaluation information and that corresponds to estimated return time to an operation by automated driving of the vehicle is equal to or greater than a third predetermined value.

20. The vehicle according to claim 18, wherein the controller is configured to start an acquiring process of the evaluation information upon determining that the vehicle has deviated from an ODD for automated driving.
